(19) United States
(12) Patent Application Publication
(10) Pub. No.: US 2011/0047088 A1
(43) Pub. Date: Feb. 24, 2011

(54) Method and System For Documenting And Validating Carbon Credits Associated With Crop Production

(75) Inventors: Todd A. Peterson, Johnston, IA (US); Daniel R. Uppena, Galena, IL (US); Michael Sanford DeFelice, Johnston, IA (US); Gregory Gerard Wandrey, Ankeny, IA (US); Dennis Alfred Judd, Urbandale, IA (US); Joseph P. Foresman, Clive, IA (US); Steven Dean Brody, Clive, IA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: PIONEER HI-BRED INTERNATIONAL, INC., Johnston, IA (US)

(21) Appl. No.: 12/841,516

(22) Filed: Jul. 22, 2010

Related U.S. Application Data
(60) Provisional application No. 61/227,536, filed on Jul. 22, 2009.

(51) Int. Cl. G06Q 99/00; G06F 17/10

(52) U.S. Cl. 705/317; 703/2

(57) ABSTRACT

Carbon credits associated with crop production may be validated. Location data and associated crop production data may be received. The validity of the carbon credit may be determined based on the location data and the associated crop production data. A carbon credit validation may be outputted based on the determination of the validity of the carbon credit.

### CROSS-REFERENCE TO RELATED APPLICATIONS

This application claims the benefit of U.S. Provisional Application Ser. No. 61/227,536 filed Jul. 22, 2009 which is incorporated herein by reference in its entirety.

### BACKGROUND

Carbon sequestration in the soil is recognized as providing a benefit to the environment because it leads to reduction in carbon dioxide content of the atmosphere. Carbon dioxide has been recognized as a greenhouse gas associated with climate change. Certain agricultural production practices can increase carbon sequestration. For example, conservation tillage, and residue management can increase soil organic carbon and thereby reduce the amount of carbon available to be transformed into carbon dioxide during decomposition. Thus, these forms of agricultural production practices are recognized as providing for enhanced carbon sequestration in agricultural systems.

Use of such agricultural production practices to enhance carbon sequestration have potential pecuniary value. Businesses who contribute to the creation of greenhouse gases may seek to offset that contribution with offsets or credits associated with these forms of agricultural production practices which lead to carbon sequestration. Businesses may do so voluntarily or, depending upon the jurisdictions they operate within, may have obligations under government regulations to do so. In some situations, landowners or crop producers may be paid a soil carbon offset by contracting to use particular crop production and management practices.

Yet problems remain with such an approach. One significant problem is ensuring that crop producers follow production practices that are consistent with the agreements into which they enter. Monitoring fields to ensure compliance takes significant resources and thus is not feasible, except possibly for the most basic of information. Thus, crop producers are generally relied upon simply to not violate the agreement.

Another problem relates to whether the carbon credits being generated from particular crop production practices reflect the carbon sequestration that occurs. Although models may be used to provide general estimates about the carbon sequestration that occurs and credits may be assigned based on these estimates, there is a significant lack of meaningful data with respect to individual fields or portions of fields or producers and as field operations interact with weather and other biotic factors to influence the carbon sequestered in the soil. Thus, the assumed amount of carbon sequestration in the soil used for contract purposes is likely not accurate, and a producer may not be fairly compensated for the actual amount of carbon sequestration in the soil occurring.

Therefore, what is needed is a method and system for collecting and validating data associated with agricultural production practices associated with carbon sequestration.

### SUMMARY

According to one aspect, a method is provided that includes receiving location data and associated crop production data. The method includes determining the validity of a carbon credit based on the location data and the associated crop production data and outputting a carbon credit validation based on said determining the validity of the carbon credit.

According to another aspect, a method is provided that includes receiving carbon credit information from at least one crop producer, wherein the carbon credit information is based on crop production practices. The method includes generating a carbon credit verification analysis. The carbon credit verification analysis is at least partially based on location data and associated crop production data collected using an automated data acquisition system associated with agricultural equipment.

According to another aspect, a computer-assisted method of validating carbon credits associated with crop production is provided. The method includes collecting time-stamped location data and associated crop production data using automated data acquisition systems associated with agricultural equipment, collecting additional crop production data, analyzing with a computer system the time-stamped location data, the associated crop production data, and the additional crop production data to assist in validating the carbon credits, and providing a carbon credit validation output from the computer system.

According to another aspect, a method of claiming carbon credits associated with crop production includes obtaining carbon credits from one or more crop producers wherein the basis for the carbon credits is based on crop production practices and receiving a computer-generated carbon credit verification analysis from a third party, the computer-generated carbon credit verification analysis being at least partially based on time-stamped location data and associated crop production data collected using automated data acquisition systems associated with agricultural equipment.

According to another aspect, a system for validating carbon credits includes a computerized analysis engine configured to receive as input location data, such as time-stamped location data, and associated crop production data collected using automated data acquisition systems associated with agricultural equipment and analyze the crop production data to provide a carbon credit validation output.

### BRIEF DESCRIPTION OF THE DRAWINGS

FIG. 1 illustrates a system for use in documenting and validating carbon credits.

FIG. 2 is a block diagram illustrating a machine with a field controller, a GPS receiver for providing geospatial data and a ground cover/biomass sensor.

FIG. 3 illustrates one example of a screen display which illustrates examples of carbon credit validation outputs.

FIG. 4 is a block diagram representing a computer system in which aspects of the present invention may be incorporated.

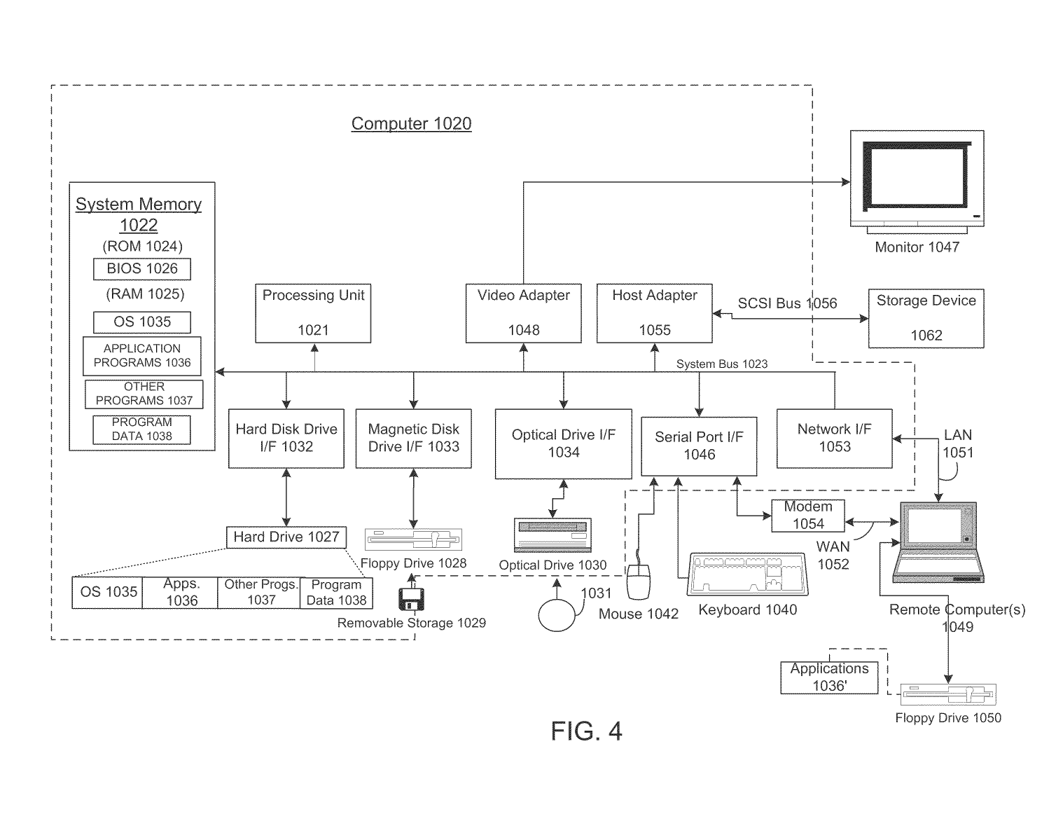

### DETAILED DESCRIPTION OF ILLUSTRATIVE EMBODIMENTS

For a better understanding of invention, a description of one form or embodiment it can take will now be set forth in detail. It is emphasized that this is but one form or embodiment for exemplary purposes only, and is not to limit the invention, which can take many forms and embodiments and have variations such as are within the skill of those of ordinary skill in the art.

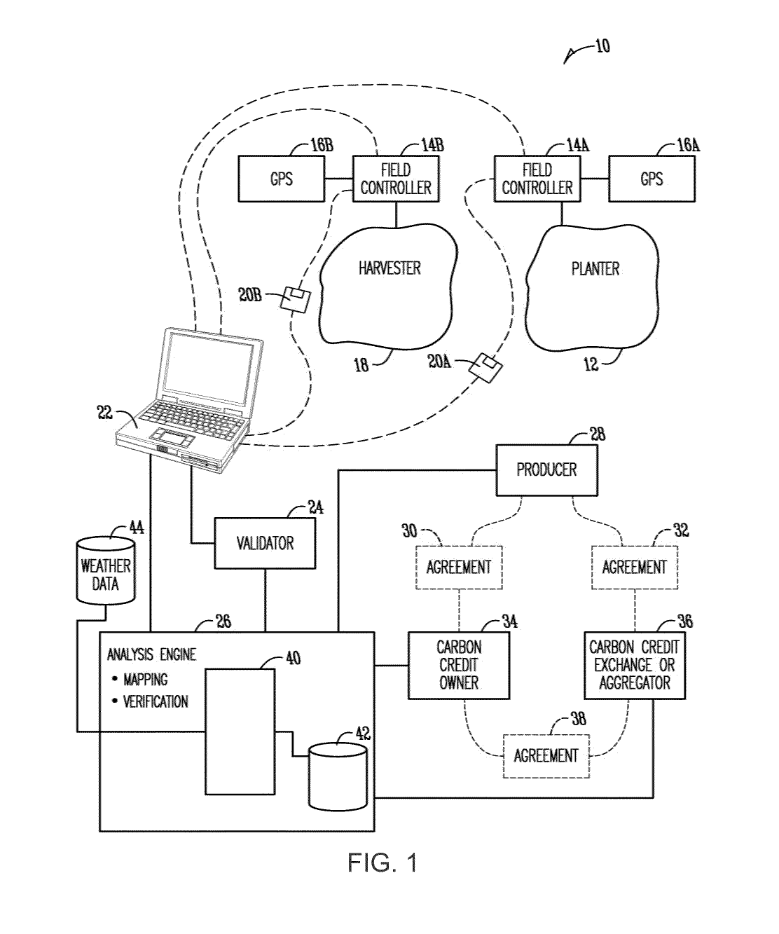

In FIG. 1, a system 10 is shown. The system 10 may provide for verifying agricultural production information associated with carbon sequestration in the soil. In FIG. 1, a planter 12 is shown. A field controller 14A is associated with the planter 12. A GPS 16A is operatively connected to the field controller 14A for providing location information. A removable storage device 20A may be used to store data collected by the field controller 14A. The removable storage device 20A may include data such as location information, crop production information, or the like. The removable storage device 20A may be conveyed to a computer 22. The data stored on the removable storage device may be used for purposes of analysis of the production methods. Alternatively, data collected by the field controller 14A may be wirelessly communicated to the computer 22. The data from the removable storage device 20A may be uploaded to a remote computer, such as computer 22 and/or 40 for example, or downloaded to a local computer, such as computer 22 and/or computer 40 for example, to be used for analysis. For example, the data from removable storage device 20A may be uploaded to computer 22 and/or computer 40 via a website accessed from a remote computer or via any other remote data transmission means.

The computer 22 may be associated with a validator 24. The validator 24 may be a third party who can validate some or all aspects of agricultural production information. The validator 24 may, but need not be, a sales representative associated with a seed company, a field agronomist, an agronomic advisor, a crop scout, or other individual or entity. In addition, the validator 24 may provide additional information about crop production which may be elicited from a crop producer or verified independently by the validator 24. For example, the validator 24 may confirm that a particular hybrid or variety of seed was purchased or planted at a particular location. Similarly, the validator 24 may confirm that no-till management practices were applied to a particular field. The information provided by the validator 24 may be provided via a computer interface and uploaded to a remote computer, such as computer 22 and/or 40 for example, or downloaded to a local computer, such as computer 22 and/or computer 40 for example, to be used for analysis. For example, the information provided by the validator 24 may be uploaded to computer 22 and/or computer 40 via a website accessed from a remote computer or via any other remote data transmission means. Of course, as previously explained, the field controller 14A or other automated equipment may be used to collect such information.

Other farm machines may produce data of use in verifying production information. For example, a harvesting machine or harvester 18 is shown. The harvester 18 is associated with a field controller 14B which is operatively connected with a GPS receiver 16B. A removable storage device 20B may be used to store data collected by the field controller 14B. The data from the removable storage device 20B may be uploaded to a remote computer, such as computer 22 and/or 40 for example, or downloaded to a local computer, such as computer 22 and/or computer 40 for example, to be used for analysis. For example, the data from removable storage device 20B may be uploaded via a website from a remote computer or via any other remote data transmission means. Alternatively, data collected by the field controller 14B may be wirelessly communicated to the computer 22.

Data from the computer 22 may be analyzed by an analysis engine 26. The analysis engine 26 may provide for mapping of the data as well as performing one or more analyses of the data useful in assisting with verifying which crop production practices are being performed and whether such crop production practices are consistent with the practices specified in a carbon credit or carbon offset agreement. In addition, the data may also be used to assist in calculating values for carbon credits or carbon offset values. For example, where a sensor is used to determine ground cover or biomass material, such information may be incorporated into a carbon sequestration model, which may be an optional part of the analysis engine 26.

The analysis engine 26 may be implemented in a computer 40 which is in operative communication with a database 42. Although shown as a separate computer, the computer 40 and computer 22 may be combined. The database 42 may store information which may assist in determining crop production practices, calculation of carbon credits, and/or information related to agreements which specify crop production practices. For example, database 42 may store parameters specified in a carbon credit agreement (such as agreement 30) and the computerized analysis engine 26 may determine if the crop production data is inconsistent with those parameters. In addition, weather data 44 may be accessed by the computer 40 or stored in the database 42. The weather data or other environmental data may be used where a carbon sequestration model is used in determining carbon credits.

Results from the analysis engine 26 may be used in various ways. For example, carbon credit owner 34 may use the information to verify that the carbon credits they have purchased or are considering purchasing are valid. Similarly, a producer 28 may use the information as evidence that the carbon credits associated with their production activities have been verified. A carbon credit exchange or aggregator 36 may also use the information as evidence that carbon credits are valid. It is to be understood that there may be a relationship between the producer 28 and the carbon credit owner 34 which is governed by the terms of an agreement 30. Similarly, there may be a relationship between the producer 28 and the carbon credit exchange or aggregator 36 that is governed by the terms of the agreement 32. Similarly, there may be an agreement 38 which governs the relationship between the carbon credit owner 34 and the carbon credit exchange or aggregator 36. Instead of separate agreements, it is contemplated that three-way (or greater) agreements may be used.

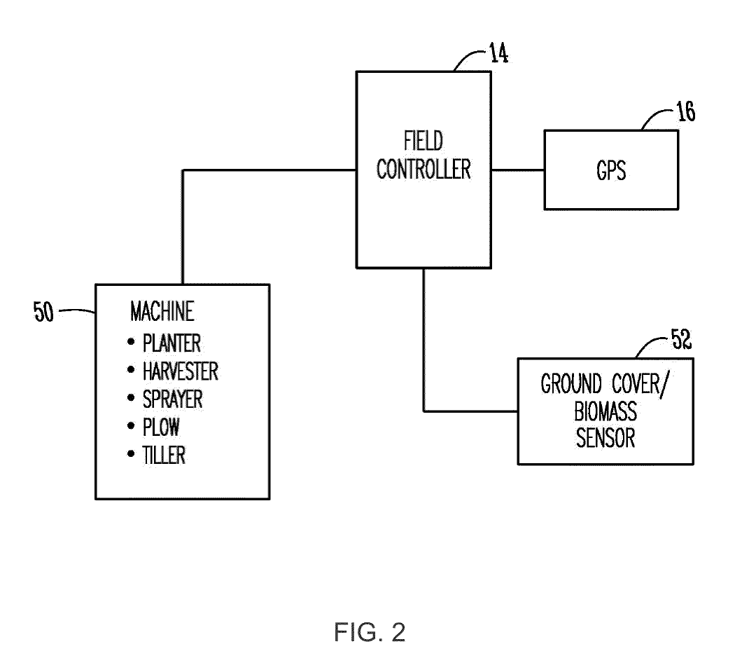

Farm machines used to perform agricultural production operations may also be equipped with sensors to provide data to assist with validation of carbon credits or carbon sequestration. FIG. 2 illustrates one example. In FIG. 2 an agricultural machine 50 is shown. The machine 50 may be a planter, harvesting machine, sprayer, tiller, or other type of machine. A data acquisition system or field controller 14 is associated with the machine 50. A GPS receiver 16 or other type of spatial positioning system is operatively connected to the field controller 14. The GPS receiver 16 is one example of a device that may be used to collect or determine location information. A ground cover or biomass sensor 52 is operatively connected to the field controller 14. The ground cover or biomass sensor 52 is one example of a remote sensor which may be used to measure the ground cover or biomass on the soil surface. Another example may be a sensor associated with a tillage implement to measure organic matter or carbon content of soil below the surface. Such information may be combined with location and time along with climate data surrounding the field operation and may be used to assist in verifying that agricultural production practices which may increase carbon sequestration are being used. Such information may also be used in combination with a carbon sequestration model. For example, the information may be used to estimate an increase in carbon sequestration and/or may be a basis for determining carbon credits and associated remuneration for the grower or landowner.

It is contemplated that additional data from data acquisition systems associated with agricultural machines may provide additional opportunities for the validation or verification of the carbon credits. Data from sensors or data acquisition systems may be stored in a memory and/or transmitted to a computer.

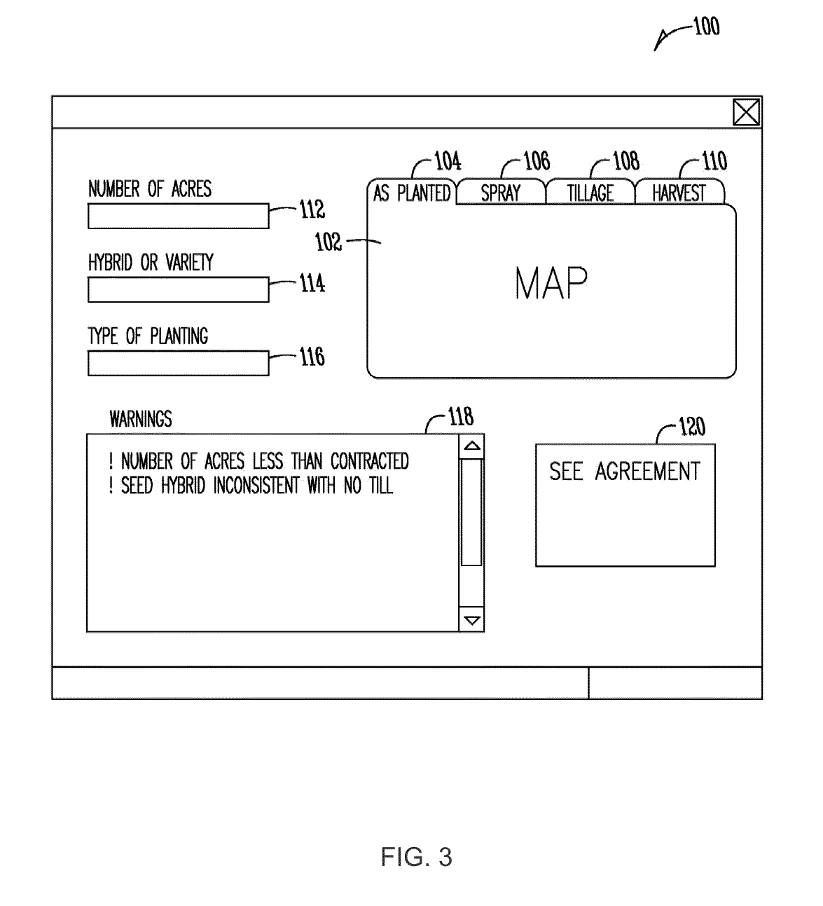

FIG. 3 illustrates one example of a user interface that may used to display the results of an analysis for verifying or determining carbon credits associated with agricultural production practices. In FIG. 3, a screen display 100 is shown. The screen display 100 may be a screen display from a computer system and may provide carbon credit validation outputs. The screen display 100 illustrates one or more maps 102. As shown in FIG. 3, an as-planted map 102 is provided on an as-planted tab 104. Additional tabs may include a spray tab 106, a tillage tab 108, and/or a harvest tab 110. There may be additional tabs for each agricultural production operation for which data is collected. In addition, data associated with the agricultural production operations may be shown. For example, additional as-planted data may include a calculation of the number of acres planted 112, the hybrid or variety planted 114, and/or the type of planting 116 which was performed. For example, the type of planting may specify the type of planter, such as a no-till planter. Other types of agricultural production data may be presented for other types of agricultural production operations.

In addition, warning conditions may be presented such as in text box 118. These warning conditions may be produced by the analysis engine when there are internal inconsistencies in the data or inconsistencies between the data and the terms of a carbon offset agreement. A “see agreement” button 120 is shown. Thus, one may access one or more agreements through the user interface so that agreements can be reviewed at any time. Alternatively, summaries of the terms of the agreement(s) may be provided. There are numerous forms of analysis which may be performed that may assist in identifying internal inconsistencies in data to indicate the validity of a carbon credit or inconsistencies between the data and the terms of the carbon offset agreement.

Number of acres in a field. One form of analysis that may be performed may include calculation of the number of acres of production. A difference in the number of acres of production may indicate the validity of a carbon credit or inconsistencies between the collected data and terms of the carbon offset agreement. Instead of relying upon estimates of acres based on aerial photographs of fields, more accurate calculations may be performed using location data, such as time-stamped production data, GPS data, or the like for example. For example, review of as-planted data which may provide time-stamped location information in addition to specific planting operation data may be used to calculate number of acres for which the specific planting operation was performed. In analyzing the number of acres for which the planting operation was performed, a polygon may be constructed that may contain all of the data points collected and the area of the polygon may be calculated. This may provide an accurate indication of the number of acres of production for which a specific planting operation was performed. This process may be repeated using harvesting data and/or other production data as well.

Hybrid or variety. A comparison of the hybrid or variety of a crop with the production practices performed in a location may also indicate the validity of a carbon credit or inconsistencies between the collected data and terms of the carbon offset agreement. For example, certain agricultural production practices, such as no-till may be used with herbicide resistant seed products. The hybrid or variety used in a particular field may be specified by the crop producer or obtained from a third party such as a seed sales representative for example. Where collected data indicates that a practice such as no-till is used with a seed product without a herbicide resistant trait, there is a potential concern with respect to whether a no-till practice was employed. Thus, such a mismatch may be used to raise a warning concerning the production practices associated with a field.

Planting operations. Location information and planting data may also be used to indicate the validity of a carbon credit or inconsistencies between the collected data and terms of the carbon offset agreement. For example, location information, such as time-stamped location information or the like, may be coupled with planting data and may be used to determine the portions of one or more fields where a particular planter or planter type was used. For example, the planting data may specify or be associated with a no-till planter. The type of planter used may provide information about production practices which may be relevant to verifying carbon credits. For example, where no-till is the production practice that underwrites the carbon credits, if the planter specified is not a no-till planter, then a warning may be raised during the verification process. Similarly, if strip-till is the production practice that underwrites the carbon credits, if the planter is not a strip-till planter, then a warning may be raised during the verification process. Similarly, if ridge-till is the production practice that underwrites the carbon credits, if the planter is not a ridge-till planter, then a warning may be raised during the verification process.

Tillage operations. Location information and tillage operation data may also be used to indicate the validity of a carbon credit or inconsistencies between the collected data and terms of the carbon offset agreement. For example, location information, such as time-stamped location information or the like, may be associated with tillage operation data that may be collected. Such information may be used to determine the areas in which a particular implement was used and the measured or estimated degree of crop residue incorporation resulting from the tillage operation. For example, if mulch-till is one of the production practices that underwrites the carbon credits, and a more aggressive tillage operation is applied or attempted, then a warning may be raised during the verification process.

Spraying operations. Location information and spraying operation data may also be used to indicate the validity of a carbon credit or inconsistencies between the collected data and terms of the carbon offset agreement. For example, location information, such as time-stamped location information and spraying operation data may be collected. Such information may be used to determine the areas in which spraying operations occurred and/or the type of spray being used. The type of spray used in particular locations may provide additional information that may be used for verifying that production practices are being performed consistent with agreements relating to carbon credits. For example, determining that spraying operations are consistent with no-till practices and/or the use of herbicide resistant seed products for the same area may serve to verify that a particular field is in compliance with a carbon offset agreement.

Coverage. Ground coverage or biomass may also be measured and/or calculated to indicate the validity of a carbon credit, indicate inconsistencies between the collected data and terms of the carbon offset agreement, calculate carbon credits, and/or calculate carbon sequestration. To calculate coverage, one or more sensors may be placed on various types of agricultural equipment. For example, one or more sensors may be placed on a planter to measure coverage after planting. Data readings associated with the ground coverage may also be associated with time and/or location information. Data associated with the ground coverage may be used to calculate biomass material. The biomass material may be used in various carbon sequestration models to calculate carbon sequestration. The results of the underlying carbon sequestration models may be used to calculate carbon credits. Such collected data may be used in performing more accurate estimates for carbon sequestration than when biomass material is estimated. Such sensors may be of any number of types suitable for use in determining ground coverage or biomass. Typically such sensors are remote sensors.

FIG. 7 and the following discussion are intended to provide a brief general description of a suitable computing environment in which the embodiments described herein may be implemented. For example, the system illustrated in FIG. 1 and the block diagram in FIG. 2, and as described herein, may be implemented, in whole or in part, as computer executable instructions performed on a computing environment as described below. Although not required, the described embodiments may be implemented in the general context of computer executable instructions being executed by a computing device, such as a client workstation or a server for example. Those skilled in the art will appreciate that the embodiments described herein may be practiced with other computer system configurations, including hand held devices, such as cellular phones, smart phones, PDAs, or the like, multi processor systems, microprocessor based or programmable consumer electronics, network PCs, minicomputers, mainframe computers, or the like. The embodiments described herein may also be practiced in distributed computing environments where tasks are performed by remote processing devices that are linked through a communications network.

Referring now to FIG. 7, an exemplary general purpose computing system is depicted. The general purpose computing system may include a conventional computer 1020 or the like, including at least one processor or processing unit 1021, a system memory 1022, and a system bus 1023 that communicatively couples various system components including the system memory to the processing unit 1021 when the system is in an operational state. The system bus 1023 may be any of several types of bus structures including a memory bus or memory controller, a peripheral bus, and a local bus using any of a variety of bus architectures. The system memory may include read only memory (ROM) 1024 and random access memory (RAM) 1025. A basic input/output system 1026 (BIOS), containing the basic routines that help to transfer information between elements within the computer 1020, such as during start up, is stored in ROM 1024. The computer 1020 may further include a hard disk drive 1027 for reading from and writing to a hard disk (not shown), a magnetic disk drive 1028 for reading from or writing to a removable magnetic disk 1029, and/or an optical disk drive 1030 for reading from or writing to a removable optical disk 1031 such as a CD ROM or other optical media. The hard disk drive 1027, magnetic disk drive 1028, and optical disk drive 1030 are shown as connected to the system bus 1023 by a hard disk drive interface 1032, a magnetic disk drive interface 1033, and an optical drive interface 1034, respectively. The drives and their associated computer-readable media provide non-volatile storage of computer readable instructions, data structures, program modules and other data for the computer 1020. Although the exemplary environment described herein employs a hard disk, a removable magnetic disk 1029 and/or a removable optical disk 1031, it should be appreciated by those skilled in the art that other types of computer readable media which can store data that is accessible by a computer, such as flash memory cards, digital video disks, random access memories (RAMs), read only memories (ROMs) and the like may also be used in the exemplary operating environment. Generally, such computer readable storage media can be used in some embodiments to store processor executable instructions embodying aspects of the present disclosure.

A number of program modules comprising computer-readable instructions may be stored on computer-readable media that may include an operating system 1035, one or more application programs 1036, other program modules 1037 and program data 1038. Computer-readable media can be any available media that can be accessed by computer 1020 and includes both volatile and non-volatile media, removable and non-removable media. By way of example, and not limitation, computer readable media may comprise computer storage media and communication media. Computer storage media may include both volatile and non-volatile, removable and non-removable media implemented in any method or technology for storage of information such as computer readable instructions, data structures, program modules or other data. Computer storage media includes, but is not limited to, RAM 1025, ROM 1024, EEPROM, flash memory or other memory technology, CD-ROM, digital versatile disks (DVD) or other optical disk storage 1031, magnetic cassettes, magnetic tape, magnetic disk storage 1029 or other magnetic storage devices, or any other medium which can be used to store the desired information and which can be accessed by computer 1020. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Upon execution by the processing unit, the computer-readable instructions cause the actions described in more detail below to be carried out. A user may enter commands and information into the computer 1020 through input devices such as a keyboard 1040 and/or pointing device 1042. These and other input devices may be connected to the processing unit 1021 through a serial port interface 1046 that is coupled to the system bus, but may be connected by other interfaces, such as a parallel port, game port or universal serial bus (USB). A display 1047 or other type of display device can also be connected to the system bus 1023 via an interface, such as a video adapter 1048. In addition to the display 1047, computers typically include other peripheral output devices (not shown), such as speakers and printers. The exemplary system of FIG. 7 also includes a host adapter 1055, Small Computer System Interface (SCSI) bus 1056, and an external storage device 1062 connected to the SCSI bus 1056.

Additionally, the computer 1020 may operate in a networked environment using logical connections to one or more remote computers, such as a remote computer 1049. The remote computer 1049 may be another computer, a server, a router, a network PC, a peer device or other common network node, and typically can include many or all of the elements described above relative to the computer 1020, although only a memory storage device 1050 has been illustrated in FIG. 7. The logical connections depicted in FIG. 7 may include a local area network (LAN) 1051 and a wide area network (WAN) 1052. Such networking environments may be commonplace in offices, enterprise wide computer networks, intranets and the Internet.

When used in a LAN networking environment, the computer 1020 may be connected to the LAN 1051 through a network interface or adapter 1053. When used in a WAN networking environment, the computer 1020 can typically include a modem 1054 or other means for establishing communications over the wide area network 1052, such as the Internet. The modem 1054, which may be internal or external, can be connected to the system bus 1023 via the serial port interface 1046. In a networked environment, program modules depicted relative to the computer 1020, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

That which has been discussed is merely representative with respect to the type of auditing or verification that may be performed with respect to carbon credits and/or carbon credit agreements. Purchasers of these carbon credits may want auditable assurances that growers actually followed the recommended practices regarding planting date, time, cultivar, tillage practice and/or the crop biomass or residue remaining on the soil following each field operation. Carbon credit accumulators and participants in carbon credit markets may want access to information that validates their purchase and ownership of those carbon offsets.

It is also contemplated that a validator 24 may further provide for verifying or auditing the data associated with carbon credits. Thus, even information that is not readily verified through automated equipment may be verified by someone other than the crop grower.

As may be appreciated, other options and alternatives are possible. As may also be appreciated, the invention may take a variety of different forms and combinations. The present invention is not to be limited to the specific examples described herein.

What is claimed:

1. A method comprising:
receiving location data and associated crop production data;
determining, via a processor, the validity of a carbon credit based on the location data and the associated crop production data; and
outputting a carbon credit validation based on said determining the validity of the carbon credit.

2. The method of claim 1, wherein the associated crop production data is data indicative of at least one agricultural production practice that can be used to indicate the validity of the carbon credit.

3. The method of claim 1, wherein the associated crop production data is indicative of at least one of crop management practices, agricultural production associated with carbon sequestration in the soil, a number of acres in a field, a hybrid or variety of seed, a planting operation, a tillage operation, or a spraying operation.

4. The method of claim 1, wherein the location data is data indicative of a land base on which a crop production operation that increases carbon sequestration is performed.

5. The method of claim 1, wherein the location data further comprises at least one of time-stamped location data or GPS data.

6. The method of claim 1, wherein the location data and associated crop production data are collected using an automated data acquisition system associated with agricultural equipment.

7. The method of claim 6, wherein the automated data acquisition system is a field controller attached to at least one of a planter, a harvesting machine, a tillage machine, or a sprayer.

8. The method of claim 1, wherein the carbon credit validation is output to a party other than a crop producer associated with the crop production data.

9. The method of claim 8, wherein the party other than the crop producer is an aggregator of carbon credits.

10. The method of claim 8, wherein the party other than the crop producer is an exchange for carbon credits.

11. The method of claim 1, wherein determining the validity of the carbon credit comprises identifying production techniques inconsistent with a carbon offset agreement.

12. The method of claim 1, wherein said determining the validity of a carbon credit further comprises using the location data and the associated crop production data in combination with a carbon sequestration model to estimate carbon credits.

13. The method of claim 12, further comprising receiving weather data and wherein determining the validity of a carbon credit further comprises using the weather data in the carbon sequestration model.

14. The method of claim 1, further comprising receiving carbon information associated with the location data; and
wherein the determining the validity of a carbon credit is further based on the carbon information.

15. The method of claim 14, wherein the carbon information is collected using a sensor to determine ground cover or biomass material.

16. The method of claim 1, wherein the associated crop production data is confirmed by a validator.

17. A method comprising:
receiving carbon credit information from at least one crop producer, wherein the carbon credit information is based on crop production practices; and
generating, via a processor, a carbon credit verification analysis, the carbon credit verification analysis being at least partially based on location data and associated crop production data collected using an automated data acquisition system associated with agricultural equipment.

18. The method of claim 17, wherein the associated crop production data comprises an estimate of ground cover.

19. The method of claim 18, wherein the automated data acquisition system comprises a remote sensing device mounted to an agricultural machine, wherein the remote sensing device is adapted to capture the estimate of ground cover.

20. The method of claim 17, wherein the carbon credit verification analysis is provided to the owner of a carbon credit associated with the carbon credit information.

21. The method of claim 17, wherein the associated crop production data comprises an estimate of above-ground biomass.

22. The method of claim 21, wherein the automated data acquisition system comprises a remote sensing device mounted to an agricultural machine, wherein the remote sensing device is adapted to capture the estimate of above-ground biomass.

23. The method of claim 17, wherein the carbon credit verification analysis is at least partially based on data collected by a seed sales representative.

24. A system comprising a computerized analysis engine configured to receive as input location data and associated crop production data collected using an automated data acquisition system associated with agricultural equipment and analyze the crop production data to provide a carbon credit validation output.

25. The system of claim 24, wherein the analysis engine is further configured to receive parameters associated with a carbon credit agreement, and wherein the carbon credit validation output identifies inconsistencies between the parameters associated with the carbon credit agreement and the crop production data.

26. The system of claim 24, wherein the system further comprises a display for displaying the carbon credit validation output.
